(19) United States
(12) Patent Application Publication
(10) Pub. No.: US 2026/0139121 A1
(43) Pub. Date: May 21, 2026

(54) ELECTROMAGNETIC WAVE GENERATOR BASED ON NON-LINEAR COMPOSITE MATERIALS

(71) Applicant: Purdue Research Foundation, West Lafayette, IN (US)

(72) Inventors: Andrew Fairbanks, Lafayette, IN (US); Allen L Garner, West Lafayette, IN (US)

(73) Assignee: Purdue Research Foundation, West Lafayette, IN (US)

(21) Appl. No.: 19/452,385

(22) Filed: Jan. 18, 2026

Related U.S. Application Data
(63) Continuation of application No. 17/698,014, filed on Mar. 18, 2022, now Pat. No. 12,534,594.
(60) Provisional application No. 63/163,895, filed on Mar. 21, 2021.

(51) Int. Cl. C08K 3/22; H01P 3/02

(52) U.S. Cl. CPC C08K 3/22; H01P 3/02; C08K 2003/2237; C08K 2003/2296; C08K 2201/001; C08K 2201/01

(57) ABSTRACT

A method for generating electromagnetic waves, includes coupling a transmission line to a direct current (DC) voltage source, the transmission line includes a first conductor, a second conductor and a composite disposed between the first conductor and the second conductor, the composite includes non-linear inclusions comprising one or more of non-linear dielectric and non-linear magnetic inclusions mixed in a matrix material, The DC voltage source has a ground that is coupled to second conductor of the transmission line, the first conductor, the second conductor, and the composite form a capacitor, charging the capacitor in the transmission line by the DC voltage source, generating an electromagnetic wave that generates a microwave burst when quickly discharging the charged capacitor, the capacitor is quickly discharged by a switch disposed after the transmission line that is configured to short the first conductor to the second conductor, thereby eliminating a need for a pulse generator.

### CROSS-REFERENCE TO RELATED APPLICATIONS

The present patent application is a continuation of U.S. Non-Provisional patent application Ser. No. 17/698,014 filed 18 Mar. 2022, which is related to and claims the priority benefit of U.S. Provisional Patent Application Ser. No. 63/163,895 filed Mar. 21, 2021, the contents of each of which are hereby incorporated by reference in its entirety into the present disclosure.

### STATEMENT REGARDING GOVERNMENT SUPPORT

This invention was made with government support under N00014-18-1-2341 awarded by the Office of Naval Research. The government has certain rights in the invention.

### TECHNICAL FIELD

The present disclosure generally relates to apparatuses for generating electromagnetic waves, and in particular, to a method and system for generating electromagnetic waves based on non-linear composite materials.

### BACKGROUND

This section introduces aspects that may help facilitate a better understanding of the disclosure. Accordingly, these statements are to be read in this light and are not to be understood as admissions about what is or is not prior art.

Transmission lines are ubiquitous in modern societies. A transmission line is generally regarded as a structure that can transfer electromagnetic energy from one point to another. These structures have sufficient length to allow formation of electromagnetic waves.

In recent history, however, a transmission line has not only been utilized to convey electromagnetic energy but to actually generate such energy, e.g., high-power microwave transmission. Towards this end, non-linear transmission lines (NLTLs) are utilized as solid-state high-power microwave (HPM) sources that utilize non-linear permittivity and/or permeability of materials to produce high power radiofrequency (RF) output. Conventional HPM sources use vacuum tubes, such as magnetrons, and require auxiliary systems, such as cryogenic cooling, electromagnets, high voltage modulators, and vacuum systems. NLTLs reduce this footprint by eliminating some of said auxiliary systems. However, traditional NLTLs still require a high voltage modulator to apply a fast (<10 ns rise time) pulse to the transmission line.

Examples of such high voltage modulators include Marx generators, pulse forming networks (PFNs), or pulse forming lines (PFLs). Marx generators allow for compact voltage multiplication, but generally do not have very fast rise times (approximately 5-50 ns). PFNs are compact and can provide large voltage outputs, although they are limited to the voltage threshold of the capacitors used therein. PFLs provide a square pulse based on the line's length and impedance and are limited by the voltage threshold of the dielectric material used therein. The PFN is a series of N number of LC ladders, made of physical capacitors C and inductors L, yielding a pulse width τ=N\sqrt{LC}. The PFL consists of coaxial cables with a dielectric separating the central cable from a metal outer conductor. Coaxial cables can also be modeled as a series of LC ladders with the capacitance and inductance given per unit length and the pulse width a function of the length of the coaxial cable.

However, each of these systems has a footprint that is too large for many applications.

Therefore, there is an unmet need for a novel configuration to generate electromagnetic waves, e.g., high-power microwave bursts utilizing an NLTL which has a reduced footprint as compared to prior art approaches.

### SUMMARY

A composite, is disclosed. The composite includes non-linear inclusions comprising one or more of non-linear dielectric and non-linear magnetic inclusions mixed in a matrix material. The non-linear dielectric inclusions are selected from the group consisting of barium strontium titanate (BST), barium titanate, strontium titanate, barium zirconate titanate, lead zirconate titanate, lead titanate, lithium niobate, potassium niobate, lead scandium tantalate, strontium barium niobate, and combinations thereof, and the non-linear magnetic inclusions are selected from the group consisting of nickel zinc ferrite (NZF), manganese zinc ferrite, cobalt ferrite, manganese ferrite, zinc ferrite, nickel ferrite, and combinations thereof. The non-linear inclusions by volume are about 25% NZF, about 10% BST/15% NZF, and about 15% BST/10% NZF.

A transmission line is also disclosed which includes a first conductor, a second conductor, and a composite disposed between the first conductor and the second conductor. The composite includes non-linear inclusions including one or more of non-linear dielectric and non-linear magnetic inclusions mixed in a matrix material. The non-linear dielectric inclusions are selected from the group consisting of barium strontium titanate (BST), barium titanate, strontium titanate, barium zirconate titanate, lead zirconate titanate, lead titanate, lithium niobate, potassium niobate, lead scandium tantalate, strontium barium niobate, and combinations thereof, and the non-linear magnetic inclusions are selected from the group consisting of nickel zinc ferrite (NZF), manganese zinc ferrite, cobalt ferrite, manganese ferrite, zinc ferrite, nickel ferrite, and combinations thereof. The non-linear inclusions by volume are about 25% NZF, about 10% BST/15% NZF, and about 15% BST/10% NZF, and wherein the first conductor, the second conductor, and the composite form a capacitor.

A system for generating electromagnetic waves is also disclosed. The system includes a voltage source, and a transmission line coupled to the voltage source. The transmission line includes a first conductor, a second conductor; and a composite disposed between the first conductor and the second conductor. The composite includes non-linear inclusions including one or more of non-linear dielectric and non-linear magnetic inclusions mixed in a matrix material. The non-linear dielectric inclusions are selected from the group consisting of barium strontium titanate (BST), barium titanate, strontium titanate, barium zirconate titanate, lead zirconate titanate, lead titanate, lithium niobate, potassium niobate, lead scandium tantalate, strontium barium niobate, and combinations thereof, and the non-linear magnetic inclusions are selected from the group consisting of nickel zinc ferrite (NZF), manganese zinc ferrite, cobalt ferrite, manganese ferrite, zinc ferrite, nickel ferrite, and combinations thereof. The non-linear inclusions by volume are about 25% NZF, about 10% BST/15% NZF, and about 15% BST/10% NZF. The voltage source has a ground that is coupled to second conductor of the transmission line. The first conductor, the second conductor, and the composite form a capacitor. The capacitor in the transmission line is charged by the voltage source and when quickly discharged, generates an electromagnetic wave.

### BRIEF DESCRIPTION OF DRAWINGS

FIG. 1 is a schematic cross-sectional diagram of a non-linear transmission line (NLTL) according to the present disclosure showing two conductors (inner and outer) with a composite disposed therebetween.

FIG. 2 is a schematic of a system for operating the NLTL of FIG. 1.

FIG. 3 is a graph of permeability of an example composite shown in FIG. 1 as a function of applied magnetic field.

FIG. 4 is a circuit diagram representation of the NLTL according to the present disclosure used as a pulse forming line (PFL) to produce a square pulse that generates electromagnetic waves.

FIGS. 5a and 5b are graphs of voltage in kV (FIG. 5a) and normalized voltage (FIG. 5b) vs. time in ns. which provide simulated voltage waveforms for a 25% nickel zinc ferrite (NZF) composite-based NLTL used as a PFL with various charging voltages and a linear transmission line (linear TL) with a charging voltage of 20 kV at the output as shown in FIG. 5a and at the output normalized to the output voltage of a linear transmission line with the same charging voltage as shown in FIG. 5b.

FIGS. 6a and 6b are graphs of power in dBW (FIG. 6a) and W (FIG. 6b) vs. frequency in GHz which show simulated output spectrum of a 25% NZF composite-based NLTL used as a PFL in dBW in FIG. 6a and in linear power after the pulse in FIG. 6b.

FIGS. 7a and 7b are graphs of voltage in kV (FIG. 7a) and normalized voltage (FIG. 7b) vs. time in ns which show simulated voltage waveforms for a 10% barium strontium titanate (BST)/15% NZF composite-based NLTL used as a PFL with various charging voltages and a linear transmission line (linear TL) with a charging voltage of 20 kV as shown in FIG. 7a and the output normalized to the output voltage of a linear transmission line with the same charging voltage as shown in FIG. 7b.

FIGS. 8a and 8b are graphs of power in dBW (FIG. 8) and W (FIG. 8b) vs. frequency in GHz which provide simulated output spectrum for a 10% BST/15% NZF composite-based NLTL used as a PFL after the initial pulse, in dBW and linear power, as a function of frequency in GHz, respectively.

FIGS. 9a and 9b are graphs of voltage in kV (FIG. 9a) and normalized voltage (FIG. 9b) vs. time in ns which provide simulated voltage waveforms for a 15% BST/10% NZF composite-based NLTL used as a PFL with various charging voltages and a linear transmission line (linear TL) with a charging voltage of 20 kV at the output as shown in FIG. 9a and the output normalized to the output voltage of a linear transmission line with the same charging voltage as shown in FIG. 9b.

FIGS. 10a and 10b are graphs of power in dBW (FIG. 10a) and W (FIG. 10b) vs. Frequency in GHz which provide simulated output spectrum of the oscillations following the applied pulse for a 15% BST/10% NZF composite-based NLTL used as a PFL in dBW, as shown in FIG. 10a, and in linear power, as shown in FIG. 10b.

FIG. 11 is a graph of voltage in kV vs. time in ns which shows that increasing the charging voltage decreased the rise time of the output pulse and caused oscillations to develop.

FIGS. 12a and 12b are graphs of power in dBW (FIG. 12a) and W (FIG. 12b) vs. frequency in GHz which show measured output spectrum of a 25% NZF composite-based NLTL used as a PFL in dBW as shown in FIG. 12a and in linear power as shown in FIG. 12b.

FIG. 13 is a graph of voltage in V vs. time in ns is provided which shows that increasing the charging voltage decreased the rise time of the output pulse and eventually induced oscillations with a lower peak-to-peak amplitude.

FIGS. 14a and 14b are graphs of power in dBW (FIG. 14a) and W (FIG. 14b) vs. frequency in GHz which show measured output spectrum of a 10% BST/15% NZF composite-based NLTL used as a PFL in dBW as shown in FIG. 14a and in linear power during the pulse as shown in FIG. 14b.

FIGS. 15a and 15b are graphs of power in dBW (FIG. 15a) and W (FIG. 15b) vs. Frequency in GHz which show measured output spectrum for a 10% BST/15% NZF composite-based NLTL used as a PFL after the initial pulse in dBW as shown in FIG. 15a and linear power as shown in FIG. 15b.

FIG. 16 is a graph of voltage in V vs. time in ns is provided which shows the measured output waveforms when testing a 15% BST/10% NZF composite-based NLTL.

FIGS. 17a, 17b, 18a, and 18b are graphs of power in dBW (FIGS. 17a and 18a) and W (FIGS. 17b and 18b) vs. Frequency in GHz are provided which show the output spectrum for oscillations during the pulse flat top and at the end of the pulse, respectively, when using a 15% BST/10% NZF composite-based NLTL.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

In the present disclosure, the term “about” can allow for a degree of variability in a value or range, for example, within 10%, within 5%, or within 1% of a stated value or of a stated limit of a range.

In the present disclosure, the term “substantially” can allow for a degree of variability in a value or range, for example, within 90%, within 95%, or within 99% of a stated value or of a stated limit of a range.

A novel approach is presented herein to generate electromagnetic waves, e.g. high-power microwaves, from a non-linear transmission line (NLTL). Towards this end, the present disclosure describes a system and method for generating high-power microwaves (HPM) with fewer auxiliary systems than conventional systems of the prior art. A compact HPM system is thus disclosed that utilizes a composite based hybrid NLTL as a pulse forming line (PFL) and HPM source as a single device. The NLTL includes a composite material as a dielectric material disposed in a coaxial configuration (i.e., cross section represents a center conductor surrounded by the composite material as a dielectric and the composite is surrounded by a shield conductor) or planar (i.e., two laterally separated conductors separated by the composite material as the dielectric). The present disclosure provides a variety of different combinations of materials that constitute the composite material, including nickel zinc ferrite (NZF) and barium strontium titanate (BST) inclusions loaded in a polydimethylsiloxane (PDMS) host material to provide magnetic field dependent permeability and electric field dependent permittivity, respectively. Non-limiting examples include: about 25% NZF, about 10% BST/15% NZF, and about 15% BST/10% NZF. By constructing the NLTL in a coaxial geometry, this device uses the capacitance, inductance, and length of the NLTL to generate a fast rise-time high voltage pulse with microwave oscillations both during and after the pulse upon exceeding a threshold charging voltage. The output frequency of the NLTLs with said composite material ranged from 950 MHz to 2.2 GHz during the pulse for 25% NZF, 10% BST/15% NZF, and 15% BST/10% NZF composites and was 1 GHz after the pulse for the 10% BST/15% NZF and 15% BST/10% NZF volume loadings. The oscillations generated after the pulse were much higher in amplitude and achieved 160 kW at a 15 kV charging voltage for the 15% BST/10% NZF composite-based NLTL.

According to one embodiment, composites with BST or NZF spherical inclusions mixed in a silicone matrix were manufactured at volume fractions ranging from 5% to 25%. The dielectric and magnetic parameters were measured from 1-4 GHz using a coaxial airline. The relative permittivity increased from 2.74±0.01 for the polydimethylsiloxane (PDMS) host material to 7.45±0.33 after combining PDMS with a 25% volume fraction of BST inclusions. The relative permittivities of BST and NZF composites were relatively constant across all measured frequencies. The relative permeability of the composites increased from 1.001±0.001 for PDMS to 1.43±0.04 for a 25% NZF composite at 1 GHz. The relative permeability of the 25% NZF composite decreased from 1.43±0.05 at 1 GHz to 1.17±0.01 at 4 GHz. The NZF samples also exhibited low dielectric and magnetic loss tangents from 0.005±0.01 to 0.091±0.015 and 0.037±0.001 to 0.20±0.038, respectively, for all volume fractions, although the dielectric loss tangent did increase with volume fraction. For BST composites, all volume fraction changes of at least 5% yielded statistically significant changes in permittivity; no changes in BST volume fraction yielded statistically significant changes in permeability. For NZF composites, the change in permittivity was statistically significant when the volume fraction varied by more than 5% and the change in permeability was statistically significant for variations in volume fraction greater than 10%. The DC electrical breakdown strength of NZF composites decreased exponentially with increasing volume fraction of NZF, while BST composites exhibited no statistically significant variation with volume fraction. It should be noted that adding as little as 10% BST to the NZF composite increased the electrical breakdown strength greater than 800%, as shown in Table 1.

TABLE 1
DC dielectric breakdown threshold in kV/cm for composites with
various volume loadings of BST and NZF in a PDMS matrix.

| | | NZF Volume Fraction (%) * | | | |
|---|---|---|---|---|---|
| | | 0 | 5 | 10 | 15 |
| BST Volume | 0 | 710.42 ± 279.07 kV/cm | 395.68 ± 111.041 | 133.51 ± 14.58 | 49.90 ± 8.64 |
| Fraction (%) | 5 | 838.86 ± 73.72 | 567.59 ± 247.00 | 392.24 ± 155.37 | N/A |
| | 10 | 585.15 ± 229.28 | 597.53 ± 68.15 | 428.50 ± 13.58 | 401.20 ± 150.73 |
| | 15 | 644.29 ± 111.25 | N/A | 423.75 ± 103.53 | N/A |

* Values are reported as the average of four measurements with error determined by standard deviation. Samples labeled N/A were not tested.

NLTLs are traditionally comprised of ferromagnetic or ferroelectric materials. Traditional gyromagnetic NLTLs utilizing ferromagnetic materials, whose permeability varies with magnetic field, rely on the precession of the magnetic moments, described by the Landau-Lifshitz-Gilbert equation, around an effective magnetic field to produce electromagnetic waves. Ferroelectric materials, whose permittivity varies with electric field, have a permanent polarization vector due to an offset titanium atom in the crystalline lattice. When the material is near the Curie temperature, the offset atom can move to alternate stable positions, thus rotating the polarization vector. When the temperature exceeds the Curie temperature, the material is in a paraelectric state, meaning that the asymmetry of the lattice disappears and the titanium atom is centered in the cubic lattice. The hysteretic behavior of the ferroelectric state is not present in the paraelectric state, although the material exhibits significant non-linearity with the permittivity decreasing with increasing electric field. Adding strontium atoms to barium titanate (BT) to form barium strontium titanate (BST) decreases the Curie temperature from 123° C. to 25° C., permitting room temperature operation. Common ferroelectric materials include BT, strontium titanate (ST), and BST.

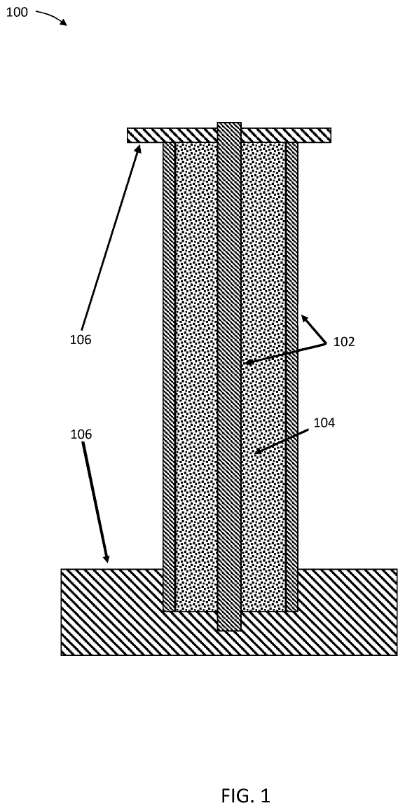

To demonstrate the concept of a low-footprint electromagnetic wave generating NLTL, a coaxial NLTL was reduced to practice using a 1 in copper tube with an internal diameter of 0.75 in as the outer conductor and a 0.5 in copper rod as the center conductor resulting in a 10Ω impedance NLTL. The composites were made by weighing the base (Part A PDMS SYLGARD 184) and adding the required amounts of NZF (FP350 PPT TECHNOLOGIES) and BST (HBS-8000 TPL INC.) to achieve the proper volume loading. The mixtures were then stirred by hand for 5 min to incorporate the powders into the PDMS base. We next placed the mixtures in a planetary centrifuge (THINKY AR100) for 5 min at 400 rpm to thoroughly mix the composites. Composites containing BST were then placed in an ultrasonic bath for 4 h to break up any conglomerations of powder. We added a curing agent at a ratio of 1:10 mass of the PDMS base, and mixed by hand for 5 min. The mixtures were then placed in a vacuum chamber at <20 kPa for 30 min to remove any air bubbles that may have been introduced. The samples were then poured slowly into the outer conductor at an angle to mitigate any addition of air into the mixture. Next, we placed the outer conductor with the composite into the vacuum chamber for 5 min at <20 kPa to remove any air that had been introduced. The center conductor was then slowly inserted into the line and was centered by an aluminum block. Again, the mixture with the center conductor inserted was placed in the vacuum chamber for 5 min at <20 kPa to remove any gas that may have been introduced. Finally, we placed another aluminum block on top of the line to ensure the center conductor was centered and placed the line in an oven (THERMO SCIENTIFIC HERATHERM OGS180) at 100° C. for 2 h to cure. FIG. 1 is a schematic cross-sectional diagram of the NLTL 100 showing two conductors (inner and outer) 102 with the composite 104 disposed therebetween and positioned between two aluminum blocks 106 that hold the center conductor in a central position while the composite 104 is cured.

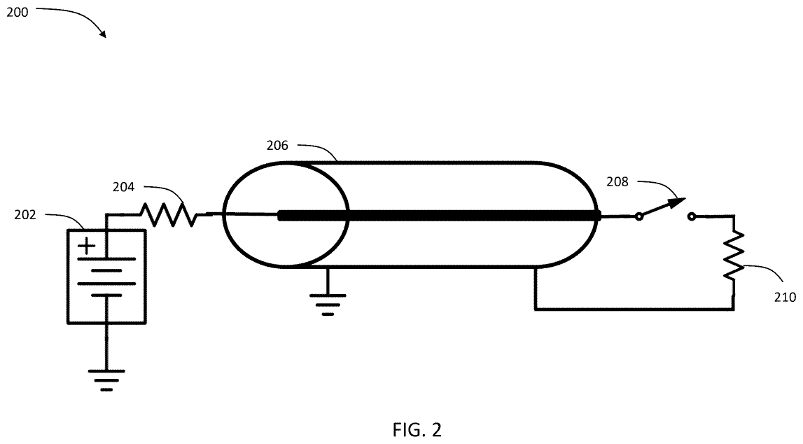

FIG. 2 is a schematic of a system 200 for operating the NLTL. The system 200 includes a DC voltage source 202 with its high side coupled to a first conductor of an NLTL 206 at a first side of the NLTL 206 of the present disclosure, via a current limiting resistor 204. The current limiting resistor may be a 5 MΩ resistor. The second conductor of the NLTL is coupled to the ground. The first conductor of the NLTL 206 is coupled to a switch 208 which when closed shorts the first conductor of the NLTL 206 to the second conductor of the NLTL 206 via an impedance matching resistor 210. When the DC voltage source 202 is first coupled to the NLTL 206, the capacitor formed between the first and second conductors of the NLTL 206 begins to charge until fully charged. When the switch 206 closes, a shockwave occurs as a result of the sudden discharge of said capacitor. Depending on the voltage level of the DC voltage source 202, the permittivity of the composite structure between the first and second conductors varies. Therefore, by adjusting the voltage, a different shockwave can be achieved. The shockwave manifests in the form of a high-power microwave burst. There are several switches that can be used for the switch 208, as known to a person having ordinary skill in the art. One such switch may be a spark gap switch.

Alternatively, instead of using a switch to generate the shockwave, a pulse generator may be used in place of the DC voltage source 202. In this embodiment, the current limiting resistor 204 is removed and the pulse generator is directly coupled to the NLTL 206. By adjusting the current which dictates the magnetic field within the NLTL 206 and the voltage of the pulse generator which dictates the electric field, the permittivity of dielectric (i.e., composite material between the first and second conductors of the NLTL 206) is varied. In so doing, the leading edge of the pulse within the NLTL 206 accelerates until it meets the lagging edge which again causes the desired shockwave.

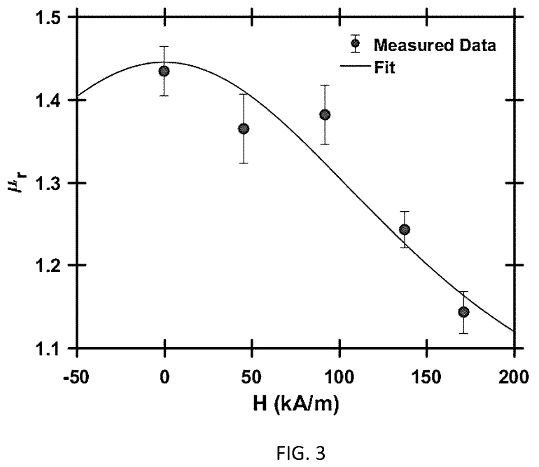

The NLTLs of the present disclosure were modeled using LT SPICE to estimate the frequency produced by the NLTL and the location of the generated oscillations relative to the pulse. The current dependent inductance was modeled by defining the flux through the inductor. The magnetic field dependence of the permeability of the NZF composites is given by

$$μ ( I ) = ( {μ}_{i} - {μ}_{S} ) [ 1 - {tanh}^{2} ( H / {H}_{s} ) ] + {μ}_{s} , \qquad ( 1 )$$

where μᵢ is the initial permeability,
μₛ is the saturation permeability (taken to be unity here),
H is the applied magnetic field, and
Hₛ is the magnetic field at which the ferrite saturates, set to 2200 G. We used the curve fitting tool in MATLAB to fit previous experimental measurements of composite permeability to equation (1) with FIG. 3 showing an example for a 25% NZF composite. Specifically, FIG. 3 shows the application of MATLAB to fit equation (1) to the measured permeability of a 25% NZF composite as a function of applied magnetic field at 1 GHz. The reported values are the average of four measurements with error bars determined by standard deviation and R²=0.8856.

The voltage dependent capacitance was calculated based on the voltage dependent permittivity, given by

$$ϵ ( V ) = ( {ϵ}_{i} - {ϵ}_{SAT} ) [ 1 - {tanh}^{2} ( ( V - {V}_{0} ) / {V}_{SAT} ) ] + {ϵ}_{SAT} , \qquad ( 2 )$$

where ϵᵢ is the initial permittivity, ϵ_{SAT} is the saturated permittivity, which is taken to be the previously measured permittivity of the composites with the given volume fraction of NZF,
V_{SAT} is the voltage at which saturation begins, and Vis the voltage. The capacitance and inductance values for each volume fraction are given in Table 2.

TABLE 2
Initial and saturated capacitance and inductance values
per inch for the constructed composite NLTLs

| | C₀ | C_{SAT} | L₀ | L_{SAT} |
|---|---|---|---|---|
| Volume Fraction | (pF/in) | (pF/in) | (nH/in) | (nH/in) |
| 25% NZF | 20.9 | 20.9 | 2.99 | 2.06 |
| 10% BST/15% NZF | 23.9 | 14.4 | 2.46 | 2.06 |
| 15% BST/10% NZF | 25.2 | 13.3 | 2.30 | 2.06 |

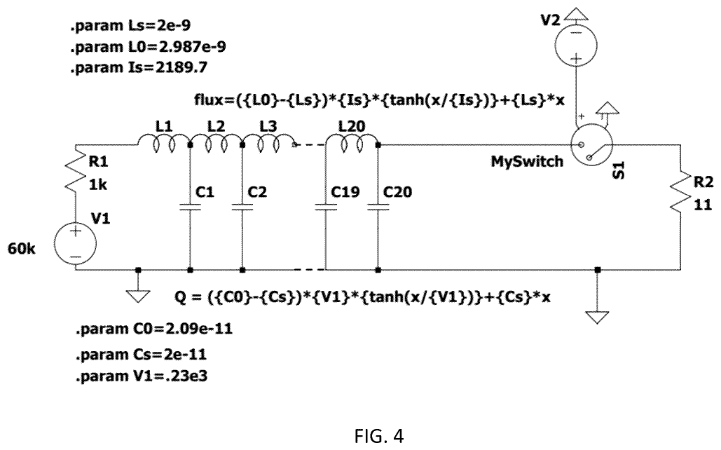

Referring to FIG. 4, a circuit diagram representation of the NLTL used as a PFL is provided to produce a square pulse that generates RF. Specifically, FIG. 4 is a general circuit schematic for a composite-based NLTL comprising non-linear dielectric and magnetic inclusions in a silicone matrix, as a PFL, where Ls is the saturated inductance, L0 is the initial inductance, Is is the current at which the saturation takes place, C0 is the initial capacitance, Cs is the saturated capacitance, and V1 is the saturation voltage. It should be noted that a separate PFL is not used to drive the NLTL, but instead we are using the NLTL as a combined PFL and HPM source; therefore, we apply a DC voltage to the NLTL instead of a pulse waveform, as shown in FIG. 2 and discussed above. The capacitance and inductance based on the dimensions of the NLTL and the material properties for the composites were determined. Specifically, the capacitance and inductance are given per inch and the NLTL is comprised of 20 LC segments to model the 20 in NLTLs that were manufactured and tested. We also simulated a linear transmission line (LTL) with fixed C=C0 and L=L0.

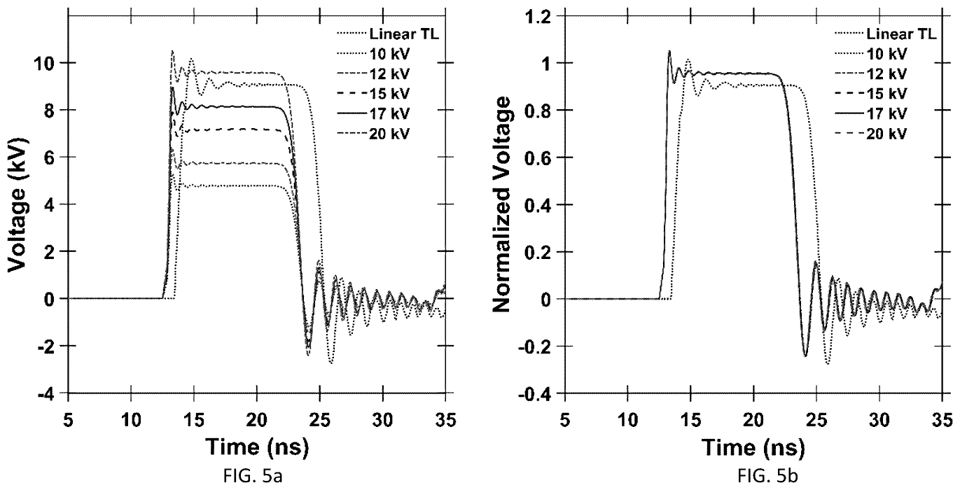

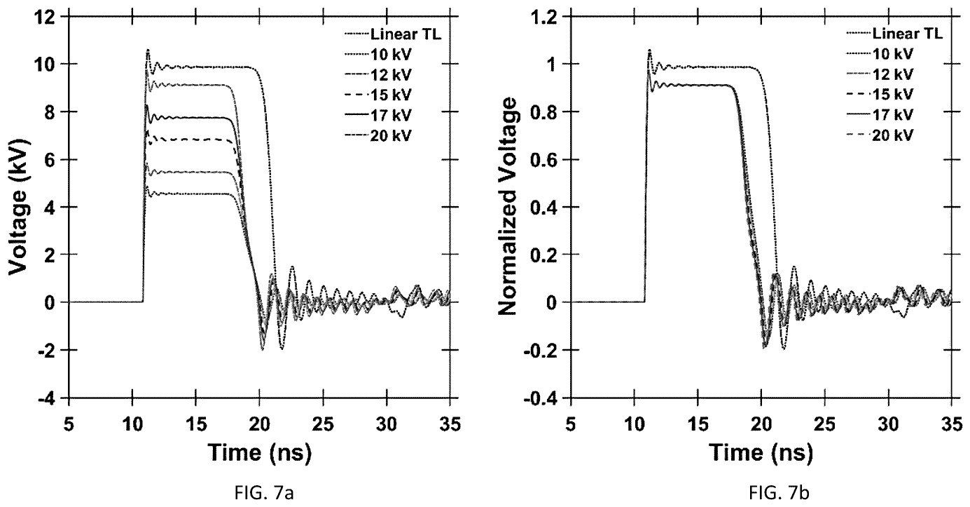

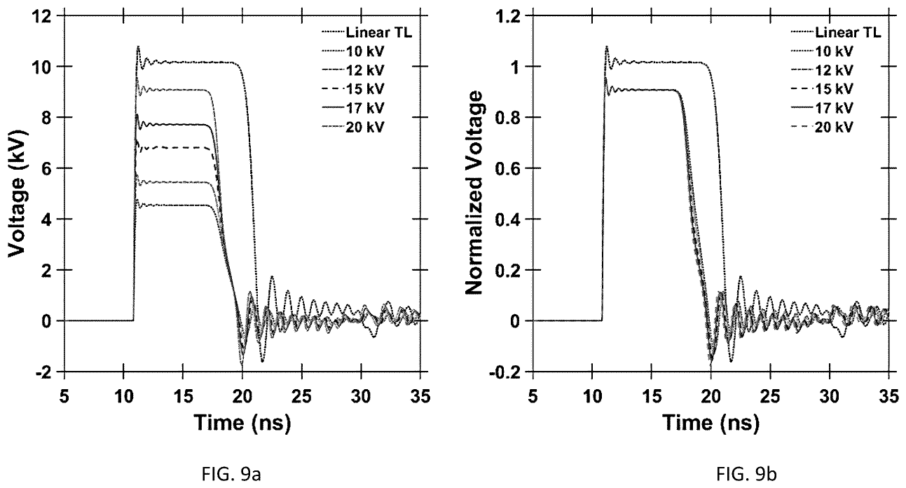

Simulation results are shown in FIGS. 5a and 5b which show the production of oscillations on the flat portion of the pulse, where conventional NLTLs produce their oscillations, and after the pulse at higher amplitudes. FIGS. 5a and 5b are graphs of voltage in kV (FIG. 5a) and normalized voltage (FIG. 5b) vs. time in ns. Specifically, FIGS. 5a and 5b provide simulated voltage waveforms for a 25% NZF composite-based NLTL used as a PFL with various charging voltages and a linear transmission line (linear TL) with a charging voltage of 20 kV at the output as shown in FIG. 5a and at the output normalized to the output voltage of a linear transmission line with the same charging voltage as shown in FIG. 5b. The output for an NLTL with 25% NZF shows strong oscillations on the output that are much higher than the oscillations produced using an LTL. It should be noted that these oscillations are not due to the Gibbs phenomenon, which occurs when the truncation of higher Fourier coefficients due to numerical filtering of the finite space and/or time steps causes superficial oscillations in the time-domain because of the truncated spectrum processed by the inverse discrete Fourier transforms (IDFT), but due to the physical initiation of oscillations. When looking at the IDFT of a truncated signal, oscillations occur before the pulse, directly after the rise time on the flat top of the pulse, directly before the fall time on the flat top of the pulse, and directly after the pulse. The LT SPICE simulations shown in FIGS. 5a and 5b (and, later, in FIGS. 7 and 9) occur only directly after the rise time and directly after the pulse. We have also performed LT SPICE simulations of other pulse conditions that may lead to the Gibbs phenomenon and do not observe these telltale oscillations. Combined, these observations indicate that the observed oscillations are not due to the Gibbs phenomenon and occur due to circuit behavior.

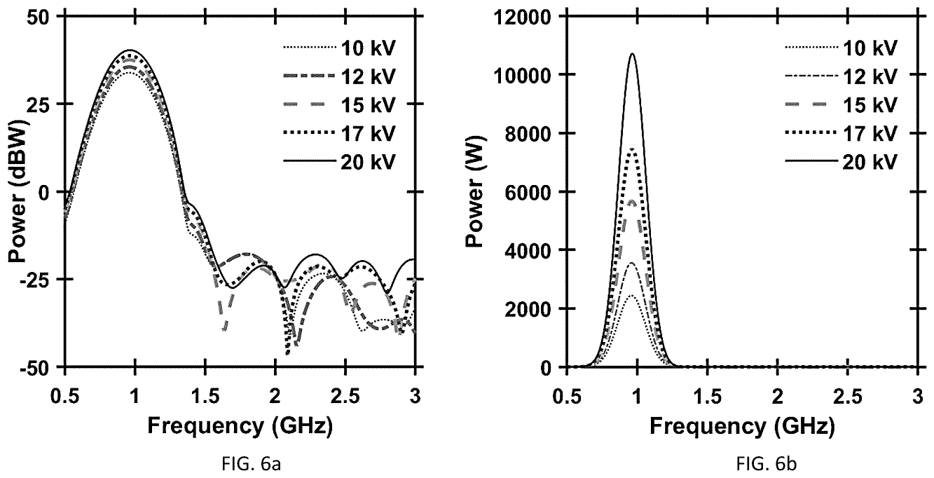

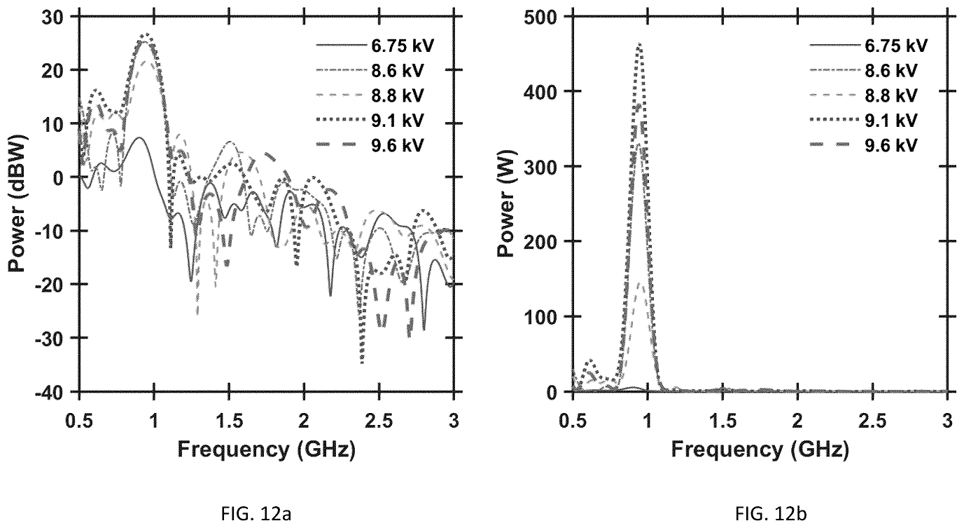

Referring to FIGS. 6a and 6b, graphs of power in dBW (FIG. 6a) and W (FIG. 6b) vs. frequency in GHz are provided. These figures show simulated output spectrum of a 25% NZF composite-based NLTL used as a PFL in dBW in FIG. 6a and in linear power after the pulse in FIG. 6b. Specifically, FIGS. 6a and 6b show the simulated spectral analysis of the oscillations that are produced after the pulse shown in FIGS. 5a and 5b. As shown, the output frequency is at 960 MHz, which matches well with the experimental data shown in FIG. 12, further discussed below. The output power of the oscillations continues to grow with increasing voltage, as seen in the experimental data.

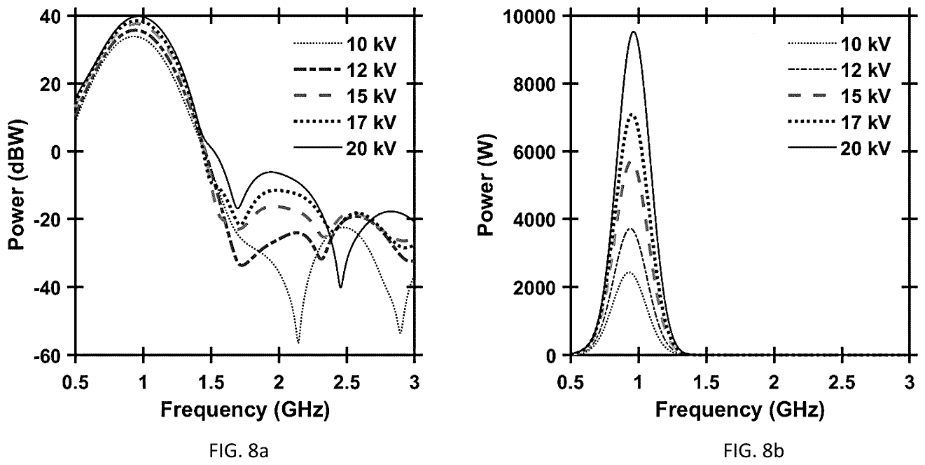

FIGS. 7a and 7b show the same analysis for a 10% BST/15% NZF composite-based NLTL. FIGS. 7a and 7b are graphs of voltage in kV (FIG. 7a) and normalized voltage (FIG. 7b) vs. time in ns. Specifically, FIG. 7a shows simulated voltage waveforms for a 10% BST/15% NZF composite-based NLTL used as a PFL with various charging voltages and a linear transmission line (linear TL) with a charging voltage of 20 kV and FIG. 7b shows the output normalized to the output voltage of a linear transmission line with the same charging voltage is shown in FIG. 7b. The output pulse of the NLTL is shorter in duration than the output pulse of the LTL due to the non-linear permittivity of the composite. The high charging voltage of the line decreases the initial permittivity to the saturated state, which increases the propagation velocity and decreases the pulse width; Vₛₐₜ determines the charging voltage for this to occur. Since we do not know V_{SAT} for our composites, we performed a parametric study and obtained V_{SAT}=2 kV as an appropriate value. The oscillations for the NLTL were also at a higher frequency (1 GHz) and amplitude than for the LTL, as shown in FIGS. 8a and 8b, which provide simulated output spectrum for a 10% BST/15% NZF composite-based NLTL used as a PFL after the initial pulse, in dBW and linear power, as a function of frequency in GHz, respectively.

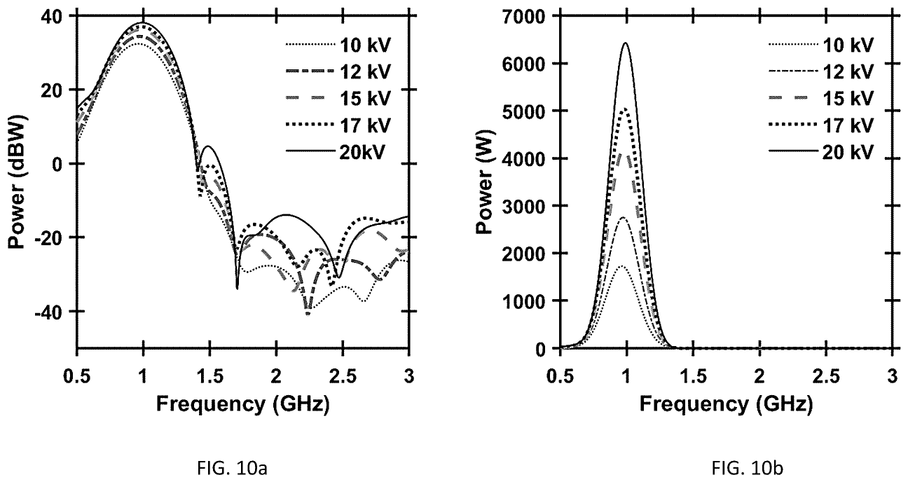

Referring to FIGS. 9a and 9b, simulation results for an NLTL comprised of 15% BST and 10% NZF are provided. FIGS. 9a and 9b are graphs of voltage in kV (FIG. 9a) and normalized voltage (FIG. 9b) vs. time in ns. Specifically, simulated voltage waveforms for a 15% BST/10% NZF composite-based NLTL used as a PFL with various charging voltages and a linear transmission line (linear TL) with a charging voltage of 20 kV at the output is shown in FIG. 9a and the output normalized to the output voltage of a linear transmission line with the same charging voltage is shown in FIG. 9b. Again, the output pulse from the NLTL is shorter in duration than that of the LTL due to the magnitude of Vₛₐₜ. The frequency of the oscillations after the flat top was 1 GHz, as shown in FIGS. 10a and 10b, which provide simulated output spectrum of the oscillations following the applied pulse for a 15% BST/10% NZF composite-based NLTL used as a PFL in dBW shown in FIG. 10a and in linear power shown in FIG. 10b. Referring to FIGS. 10a and 10b, graphs of power in dBW (FIG. 10a) and W (FIG. 10b) vs. Frequency in GHz are provided.

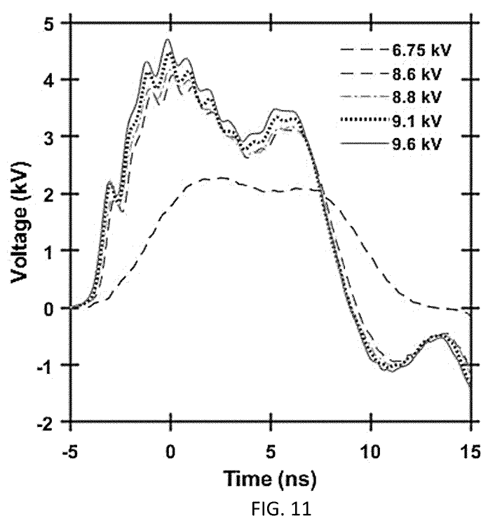

The 25% NZF composite-based NLTL was tested at different voltages to determine the output frequency of oscillations. FIG. 11 is a graph of voltage in kV vs. time in ns which shows that increasing the charging voltage decreased the rise time of the output pulse and caused oscillations to develop. Specifically, FIG. 11 provides measured output voltage waveforms from a 25% NZF composite-based NLTL used as a PFL. The RF burst had a duration of 5 ns. Increasing the charging voltage produced a small current draw when only NZF inclusions were used, resulting in a voltage drop across the charging resistor that limited the maximum charging voltage of the NLTL. This prevented the charging voltage from reaching the values in simulation where oscillations form after the pulse and during the pulse, and much lower output power at corresponding charging voltages.

The generated oscillations were centered around 950 MHz and occur at the peak of the output waveform, in agreement with the simulations. Referring to FIGS. 12a and 12b, graphs of power in dBW (FIG. 12a) and W (FIG. 12b) vs. frequency in GHz are provided. FIGS. 12a and 12b show that the output power of the oscillations generally increased with increasing charging voltage. Specifically, measured output spectrum of a 25% NZF composite-based NLTL used as a PFL are provided in dBW as shown in FIG. 12a and in linear power as provided in FIG. 12b. FIG. 12b shows that while the power of the output peak is slightly higher for a charging voltage of 9.1 kV than for 9.6 kV, the output power was more concentrated at 950 MHz for the 9.6 kV peak since the power at frequencies slightly below 950 MHz was much lower for the 9.6 kV charging voltage than for the 9.1 kV charging voltage, making the overall fraction of power at 950 MHz higher compared to the surrounding frequencies for the 9.6 kV charging voltage. For a charging voltage of 9.1 kV, the output power of the line exceeded 400 W at 950 MHz.

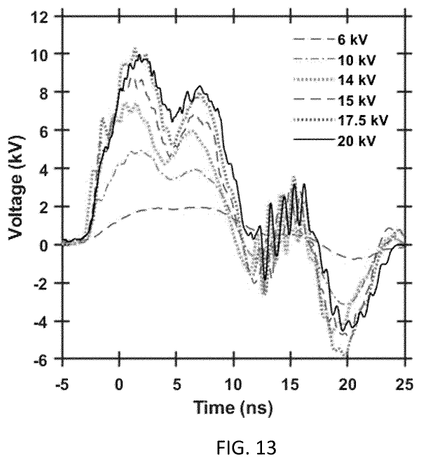

These measurements were repeated for a 10% BST/15% NZF composite-based NLTL. Referring to FIG. 13, a graph of voltage in V vs. time in ns is provided. FIG. 13 shows that increasing the charging voltage decreased the rise time of the output pulse and eventually induced oscillations with a lower peak-to-peak amplitude than those in the flat top, in agreement with the simulation results from FIGS. 7a and 7b. Increasing the charging voltage to 14 kV created oscillations after the pulse, which increased in amplitude with increasing charging voltage.

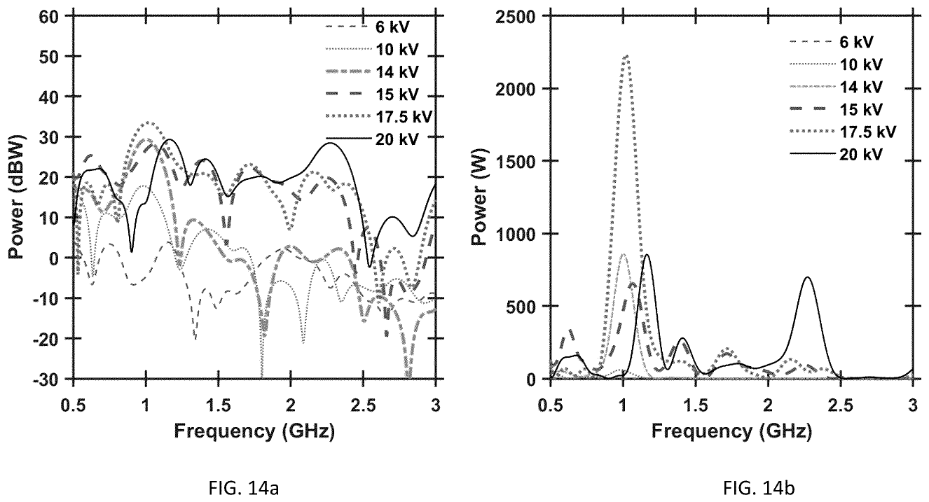

Referring to FIGS. 14a and 14b, graphs of power in dBW (FIG. 14a) and W (FIG. 14b) vs. Frequency in GHz are provided. Specifically, measured output spectrum of a 10% BST/15% NZF composite-based NLTL used as a PFL in dBW is provided in FIG. 14a and in linear power during the pulse is shown in FIG. 14b. These figures show that the oscillations produced on the flat top of the pulse were centered at 1 GHz, agreeing well with frequency of the oscillations shown in the simulations. The output power of the oscillations during the flat top increased with increasing charging voltage except when oscillations were formed after the pulse. For a comparable charging voltage, the output power for the 10% BST/15% NZF composite-based NLTL was less than that of the 25% NZF composite-based NLTL. Specifically, FIG. 14b shows that increasing the charging voltage introduced a secondary frequency at 2.27 GHz and increased the frequency of the first peak to 1.17 GHz. The output power at 20 kV was divided primarily between the two main peaks at 1.17 GHz and 2.27 GHz.

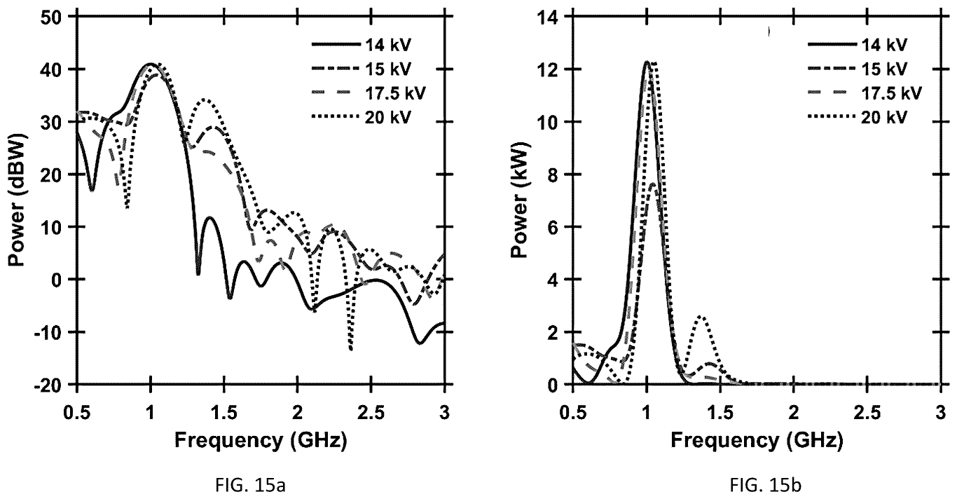

Referring to FIGS. 15a and 15b, graphs of power in dBW (FIG. 15a) and W (FIG. 15b) vs. Frequency in GHz are provided. Specifically, measured output spectrum for a 10% BST/15% NZF composite-based NLTL used as a PFL after the initial pulse in dBW is shown in FIG. 15a and linear power is shown in FIG. 15b. These figures show the output spectrum for the oscillations after the pulse obtained by performing a power spectrum density of the post-pulse oscillations. The amplitude of the oscillations after the pulse generally increased with charging voltage, exceeding those during the pulse by almost an order of magnitude. A second peak is also generated at 1.42 GHz and 1.36 GHz for a 15 kV and 20 kV charging voltage, respectively. The output power was also distributed between higher frequencies for charging voltages above 14 kV, as shown in FIG. 15a.

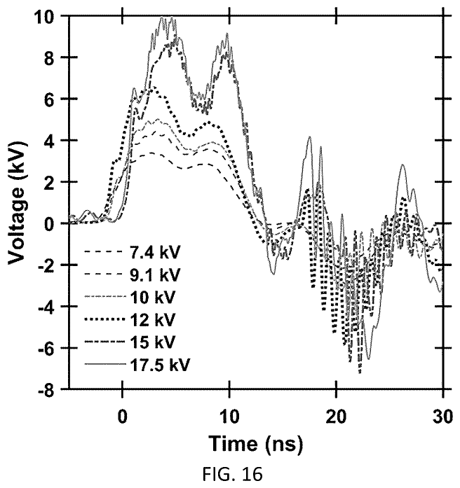

Referring to FIG. 16, a graph of voltage in V vs. time in ns is provided. FIG. 16 shows the measured output waveforms when testing a 15% BST/10% NZF composite-based NLTL. We charged the NLTL to a higher voltage until breakdown occurred across the outside of the spark gap. Increasing the charging voltage reduced the rise time and produced oscillations. Charging the NLTL to 10 kV or above produced stronger oscillations after the pulse (4.83 kV) than on the flat top of the pulse (0.61 kV). The RF burst on the flat top of the pulse had a duration of 5 ns, while the strong oscillations after the pulse had a duration of 10 ns.

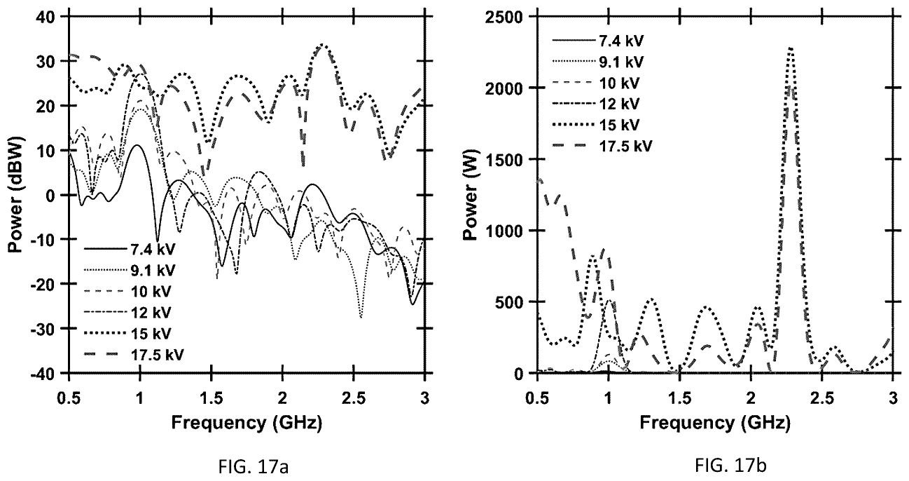

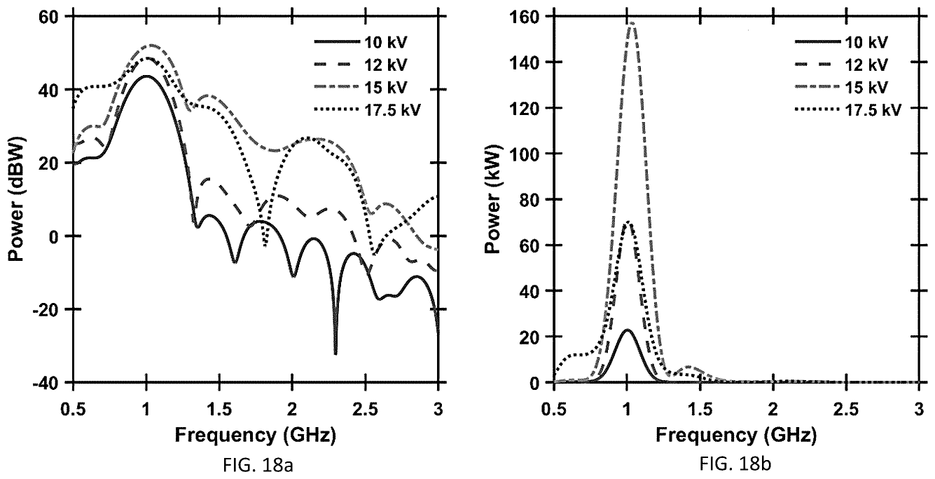

Referring to FIGS. 17a and 17b and FIGS. 18a and 18b, graphs of power in dBW (FIGS. 17a and 18a) and W (FIGS. 17b and 18b) vs. Frequency in GHz are provided. These figures show the output spectrum for oscillations during the pulse flat top and at the end of the pulse, respectively, when using a 15% BST/10% NZF composite-based NLTL. The output power of the oscillations on the pulse flat top increased with increasing charging voltage, producing higher overall output power. The oscillations were centered around 1 GHz, in agreement with simulation, until increasing the charging voltage to 15 kV, which produced a large peak at 2.28 GHz that also occurred for the 10% BST/15% NZF composite-based NLTL. The amplitude of the oscillations after the pulse flat top for this composite-based NLTL exceeded those on the flat top of any of the composite-based NLTLs in this study. FIG. 18 shows that the oscillations following the flat top were centered around 1 GHz at all charging voltages and increased in power with increasing charging voltage until reaching a peak power of ˜160 kW at a 15 kV charging voltage.

Those having ordinary skill in the art will recognize that numerous modifications can be made to the specific implementations described above. The implementations should not be limited to the particular limitations described. Other implementations may be possible.

1. A method for generating electromagnetic waves, comprising:
coupling a transmission line to a direct current (DC) voltage source;
wherein the transmission line, comprising:
a first conductor;
a second conductor, and
a composite disposed between the first conductor and the second conductor;
the composite, comprising:
non-linear inclusions comprising one or more of non-linear dielectric and non-linear magnetic inclusions mixed in a matrix material,
wherein the DC voltage source has a ground that is coupled to second conductor of the transmission line,
wherein the first conductor, the second conductor, and the composite form a capacitor;
charging the capacitor in the transmission line by the DC voltage source;
generating an electromagnetic wave that generates a microwave burst when quickly discharging the charged capacitor,
whereby the capacitor is quickly discharged by a switch disposed after the transmission line that is configured to short the first conductor to the second conductor, thereby eliminating a need for a pulse generator.

2. The method of claim 1, wherein the non-linear dielectric inclusions are selected from the group consisting of barium strontium titanate (BST), barium titanate, strontium titanate, barium zirconate titanate, lead zirconate titanate, lead titanate, lithium niobate, potassium niobate, lead scandium tantalate, strontium barium niobate, and combinations thereof, and the non-linear magnetic inclusions are selected from the group consisting of nickel zinc ferrite (NZF), manganese zinc ferrite, cobalt ferrite, manganese ferrite, zinc ferrite, nickel ferrite, and combinations thereof.

3. The method of claim 1, wherein the non-linear inclusions by volume are about 25% NZF/about 75% insulator material, about 10% BST/15% NZF/about 75% insulator material, or about 15% BST/10% NZF/about 75% insulator material.

4. The method of claim 1, wherein the composite has a permittivity between about 2.1 to about 1000.

5. The method of claim 1, wherein the composite has a permeability between about 1.5 to about 15.

6. The method of claim 1, wherein the matrix material is selected from the group consisting of silicon, ceramic, polydimethylsiloxane, and a combination thereof.

7. The method of claim 1, wherein the first and the second conductors are disposed in a coaxial configuration.

8. The method of claim 1, wherein the first and the second conductors are disposed in a planar configuration.

9. The method of claim 1, wherein an electrical load is provided after the switch.

10. The method of claim 9, wherein the electrical load is an antenna or an impedance matching resistor.

11. A transmission line, comprising:
a first conductor;
a second conductor; and
a composite disposed between the first conductor and the second conductor;
the composite, comprising:
non-linear inclusions comprising one or more of non-linear dielectric and non-linear magnetic inclusions mixed in a matrix material,
wherein the non-linear dielectric inclusions are selected from the group consisting of barium strontium titanate (BST), barium titanate, strontium titanate, barium zirconate titanate, lead zirconate titanate, lead titanate, lithium niobate, potassium niobate, lead scandium tantalate, strontium barium niobate, and combinations thereof, and the non-linear magnetic inclusions are selected from the group consisting of nickel zinc ferrite (NZF), manganese zinc ferrite, cobalt ferrite, manganese ferrite, zinc ferrite, nickel ferrite, and combinations thereof,
wherein the non-linear inclusions by volume are about 25% NZF/about 75% insulator material, about 10% BST/15% NZF/about 75% insulator material, or about 15% BST/10% NZF/about 75% insulator material; and
wherein the first conductor, the second conductor, and the composite form a capacitor.

12. The transmission line of claim 11, wherein when the capacitor is charged by a direct current (DC) source and then quickly discharged, the capacitor is configured to generate an electromagnetic wave that generates a microwave burst.

13. The transmission line of claim 12, whereby the capacitor is quickly discharged by a switch disposed after the transmission line that is configured to short the first conductor to the second conductor.

14. The transmission line of claim 11, wherein the composite has a permittivity of between about 2.1 to about 1000.

15. The transmission line of claim 11, wherein the composite has a permeability of between about 1.5 to about 15.

16. The transmission line of claim 11, wherein the matrix material is selected from the group consisting of silicon, ceramic, polydimethylsiloxane, and a combination thereof.

17. The transmission line of claim 11, wherein the first and the second conductors are disposed in a coaxial configuration.

18. The transmission line of claim 11, wherein the first and the second conductors are disposed in a planar configuration.
